(19) United States
(12) Patent Application Publication
(10) Pub. No.: US 2024/0157827 A1
(43) Pub. Date: May 16, 2024

(54) COOLING DEVICE FOR COOLING AT LEAST ONE ELECTRIC LINE WHICH IS CONNECTED TO A PLUG CONNECTOR PART

(71) Applicant: PHOENIX CONTACT E-Mobility GmbH, Schieder-Schwalenberg (DE)

(72) Inventors: Thomas Fuehrer, Blomberg (DE); Robert Babezki, Steinheim (DE)

(21) Appl. No.: 18/548,239

(22) PCT Filed: Feb. 21, 2022
(86) PCT No.: PCT/EP2022/054257

§ 371 Date: Aug. 29, 2023

(30) Foreign Application Priority Data
Mar. 4, 2021 (BE) BE2021/5164

(51) Int. Cl. B60L 53/302; B60L 53/16

(52) U.S. Cl. CPC B60L 53/302; B60L 53/16

(57) ABSTRACT

A cooling device for cooling at least one electric line which is connected to a plug connector part includes: a cooling module disposable on the at least one electric line and having a cooling channel for flowing coolant therethrough, the cooling module having two housing assemblies, each of which has a respective connection section and a flow opening molded onto the connection section, the two housing assemblies being separate in a preassembly state and being connectable together to be placed on the at least one electric line such that the at least one electric line is received between the housing assemblies. The flow openings of the connection sections of the two housing assemblies are fluidically connected together to form the cooling channel.

### CROSS-REFERENCE TO PRIOR APPLICATIONS

This application is a U.S. National Phase application under 35 U.S.C. § 371 of International Application No. PCT/EP2022/054257, filed on Feb. 21, 2022, and claims benefit to Belgian Patent Application No. BE 2021/5164, filed on Mar. 4, 2021. The International Application was published in German on Sep. 9, 2022 as WO/2022/184489 under PCT Article 21(2).

### FIELD

The invention relates to a cooling device for cooling at least one electric line, connected to a plug connector part.

### BACKGROUND

Such a cooling device has a cooling module which can be placed on the at least one electric line and has a cooling channel through which a coolant can flow.

A plug connector part which is to be cooled using the cooling device can be, for example, a component of a charging system for charging an electric vehicle. Within the scope of such a charging system, an electric vehicle is connected via a charging cable to a charging station by inserting a plug connector part in the form of a charging plug on the charging cable into an associated plug connector part in the form of a charging socket on the electric vehicle, for example.

Charging currents can be transmitted as direct currents or as alternating currents, in particular charging currents in the form of direct current having a high current intensity, for example more than 350 A or even more than 500 A, and can lead to heating of the cable as well as a plug connector part connected to the cable.

In general, heating on a cable, in particular a charging cable, and a plug connector part connected to the cable, can be at least slowed down in that current-carrying assemblies are oversized. For example, lines in a cable can be designed having a comparatively large cross section, in order to increase the current-carrying capacity of such lines. In addition, contact elements of a plug connector part can also be oversized, in order to counteract excessive heating on the contact elements of the plug connector part. Additionally or alternatively, an active cooling can be made available using cooling lines through which a coolant flows.

Oversizing of current-carrying components and, if applicable, additional measures for active cooling, are conventionally used in charging systems for charging an electric vehicle, in particular on the side of a charging station and a charging cable connected thereto. A plurality of charging processes are usually carried out in succession at a charging station, so that current-carrying components are to be dimensioned for quasi-continuous operation.

In contrast, on the side of an electric vehicle, current-carrying components are usually undersized. Such current-carrying components are generally to be designed such that currents can be transmitted with sufficient current-carrying capacity during a charging process, wherein it is possible for the current-carrying components to cool down again after a completed charging process. For example, in a direct current (DC) fast charging process, a thermal load is thus limited to a comparatively short period of time, for example 30 minutes.

For heating during operation, normative limits can be specified. For example, for a plug connector part in the form of a charging socket on the side of an electric vehicle, it is possible to normatively specify that heating may not lead to a temperature greater than 90° C. For a electric line in the form of a load line, which is connected to the plug connector part and connects the plug connector part to vehicle batteries, for example, such a limit may possibly be significantly higher, for example at 180° C. Due to the higher temperature limit for electric lines connected to the plug connector part, such lines can usually be undersized, which in operation results in stronger heating on the lines. This in turn can lead to thermal energy being introduced from the lines into the plug connector part, so that increased heating occurs at the plug connector part by heat transfer from the connected lines.

There is a need to counteract such effects, in particular in a charging system for charging an electric vehicle.

A charging cable known from DE 10 2010 007 975 B4 has a cooling line which comprises a supply line and a return line for a coolant, thus allowing for coolant flow back and forth in the charging cable. In this case, the cooling line of DE 10 2010 007 975 B4 serves for discharging thermal losses arising at an energy store of a vehicle, but also for cooling the cable itself.

EP 3 611 738 A1 discloses a cooling sleeve for dissipating heat from at least one power line, in which the power line is guided through a grommet. The grommet is surrounded by a housing. A cooling volume is formed between the grommet and the housing, through which a coolant can flow.

DE 10 2017 120 725 A1 describes a heat removal device for attaching to an electric line, having a flexible or non-rigid, sleeve-like or tubular main body, which has a coolant space enclosed between an inner wall and an outer wall, and a passage opening adjoining the inner wall for receiving the line.

DE 20 2020 002 915 U1 describes a device for cable channel cooling without external energy consumption, which consists of a flexible, tubular plastics jacket having an integrated two-stage, separate latent heat accumulator cooling system and having an opening portion for inserting or removing a power cable.

### SUMMARY

In an embodiment, the present invention provides a cooling device for cooling at least one electric line which is connected to a plug connector part, comprising: a cooling module disposable on the at least one electric line and having a cooling channel for flowing coolant therethrough, the cooling module having two housing assemblies, each of which has a respective connection section and a flow opening molded onto the connection section, the two housing assemblies being separate in a preassembly state and being connectable together to be placed on the at least one electric line such that the at least one electric line is received between the housing assemblies, wherein the flow openings of the connection sections of the two housing assemblies are fluidically connected together to form the cooling channel.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a view of a charging system having a charging station and an electric vehicle to be charged;

FIG. 2 shows a view of an embodiment of a plug connector part in the form of a charging plug of an electric vehicle;

FIG. 3 shows a rear view of the plug connector part according to FIG. 2;

FIG. 4 shows a view of the plug connector part having a cooling device which is attached to lines which are connected to the plug connector part;

FIG. 5 shows a separate view of a cooling module of the cooling device;

FIG. 6 shows a view of housing assemblies of the cooling module of the cooling device;

FIG. 7 shows a view of a body element and a housing cover of a housing assembly;

FIG. 8 shows a view of the cover element of the other housing assembly;

FIG. 9 shows an exploded view of the cooling module;

FIG. 10 shows a perspective partial sectional view of the cooling module;

FIG. 11 shows another sectional view through the cooling module along the line A-A according to FIG. 10;

FIG. 12 shows in turn another sectional view through the cooling module along the line B-B according to FIG. 10; and

FIG. 13 shows a sectional view along the line C-C according to FIG. 10.

### DETAILED DESCRIPTION

In an embodiment, the present invention provides a cooling device for cooling at least one electric line connected to a plug connector part, which cooling device enables active cooling, in particular for counteracting a heat transfer from the line to the connected plug connector part, and which can in the process be attached in a simple manner to a line, for example on a plug connector part on an electric vehicle.

According thereto, in the cooling device, the cooling module has two housing assemblies, each having a connection section and a flow opening molded onto the connection section. The housing assemblies are separate in a preassembly state and can be connected together in order to be placed on the at least one electric line such that the at least one electric line is received between the housing assemblies, and the flow openings of the connection sections of the housing assemblies are fluidically connected together in order to form the cooling channel.

In the case of the cooling device, a cooling module is formed by housing assemblies which are separate in a pre-assembly state before attachment to the associated electric line, and can be attached to one another in order to provide cooling on the line. The housing assemblies together form a cooling channel through which a coolant can flow during operation so that heat can be absorbed and transported away via the coolant, at the cooling module and at the line on which the cooling module is placed.

The fact that the cooling module has two housing assemblies which are formed separately from one another and are separate from one another in the preassembly state and which can be placed on one another for attachment to the line results in a simple assembly of the cooling device on an associated line to be cooled. Due to the fact that the cooling device can be attached to an associated line in a simple manner by joining the housing assemblies, in particular the possibility of retrofitting the cooling device in an already existing electrical system, in particular a charging system for charging an electric vehicle, arises.

If cooling on a line is to be provided, the housing assemblies are placed on the line and are connected to one another so that the line is received between the housing assemblies and thus heat can be absorbed and dissipated at the line during operation.

The housing assemblies can be connected for example by screwing. Alternatively or additionally, the housing assemblies can, for example, be connected to one another in a form-fitting manner, for example by establishing a latching connection, in order to attach the cooling module to the associated line to be cooled.

Each housing assembly has a connection section and a flow opening formed on the connection section. When connecting the housing assemblies to one another, the connection sections come into contact with one another in such a way that the flow openings of the housing assemblies are fludically connected to one another. In this way, a cooling channel is provided which extends in the two housing assemblies and through which coolant can flow through during operation so that heat can advantageously be absorbed on both housing assemblies and can be discharged via the coolant flow.

The cooling device can be mounted, for example, at one end of an electric line at which the electric line is connected to the plug connector part. The cooling device can thus provide cooling, in particular at a transition between the electric line and the plug connector part, as a result of which it is possible to prevent heat being able to be introduced from the line into the plug connector part. If, during operation, (excessive) heating occurs on the line, heat can be absorbed and dissipated at the cooling device before it can be introduced into the plug connector part and leads to excessive, possibly inadmissible, heating on the plug connector part.

In one embodiment, each housing assembly has at least one cooling channel portion for forming the cooling channel. In this case, the at least one cooling channel portion of one housing assembly is fluidically connected to the at least one cooling channel portion of the other of the housing assemblies when the housing assemblies are connected to one another. The cooling channel portions form the cooling channel, which thus extends in both housing assemblies so that coolant can flow through the housing assemblies during operation and thus heat can be absorbed and dissipated at both housing assemblies.

In this case, a connection between the cooling channel portions is produced via the flow openings at the connection sections of the housing assemblies. Since the housing assemblies are brought into contact with one another by the connection sections, the flow openings are fluidically connected to one another and the cooling channel portions of the housing assemblies are thus connected to one another in such a way that a coolant can flow between the cooling channel portions.

In one embodiment, at least one of the housing assemblies has a body element and a cover element connected to the body element. The body element defines a flow space in which coolant can flow and in which the at least one cooling channel portion extends.

It is conceivable that only one of the housing assemblies has such a body element and a cover element connected to the body element. In another embodiment, however, both housing assemblies each have a body element and a cover element connected to the body element.

In one embodiment, the cover element has a surface portion that defines the flow space and at least one wall portion formed on the surface portion for defining the at least one cooling channel portion. The surface portion closes the flow space of the body element to the outside so that coolant can flow into the flow space, wherein it is possible for coolant to be introduced into the flow space in a defined manner and also discharged from the flow space again, for example via connection elements of the cooling module. In order in this case to specify a defined flow path in the flow space, one or more wall portions are formed on the surface portion, which define one or more cooling channel portions along which the coolant is guided when the coolant flows through the flow space during operation.

The wall portions can be formed, for example, as webs extending perpendicularly to the surface portion of the cover element. In this case, a cooling channel portion can be formed, for example, between wall sections extending in parallel with one another, so that coolant can flow along the wall portions during operation.

In one embodiment, the at least one wall portion extends towards the connection section of the associated housing assembly in such a way that the at least one wall portion divides the flow opening into multiple channel openings. The wall portion thus also extends in the region of the flow opening on the connection section of the associated housing assembly. The wall portion divides the flow opening into multiple channel openings separated from one another, via which coolant can flow between the housing assemblies. In this case, each channel opening can be associated with a cooling channel portion on the side of each housing assembly, so that coolant can flow through a channel opening from a cooling channel portion of the one housing assembly into an associated cooling channel portion of the other of the housing assemblies. Since multiple channel openings separated from one another are provided, coolant can be guided back and forth between the housing assemblies via cooling channel portions, so that a comparatively long flow path can be provided and heat can be efficiently absorbed at the electric line.

In one embodiment, one or more flow elements, for example in the form of projections, are formed on the surface portion of the cover element, said flow elements protruding into one or more cooling channel portions of the associated housing assembly. By means of such flow elements, a coolant flow can, for example, be shaped by the cooling channel, for example swirled or diverted, for example in order to slow down the flow rate of the coolant flow and thus improve heat absorption. In this case, one or more flow elements can project from the surface portion into the interior of the flow space of the body element, in order to shape a coolant flow in the interior of the flow chamber in a suitable manner.

In one embodiment, the cooling module has a sealing element which is arranged between the connection sections of the housing assemblies. A transition between the housing assemblies in the region of the connection sections is sealed by the sealing element, so that coolant cannot flow out at the transition between the connection sections, but rather can be introduced from one housing assembly into the other housing assembly.

The sealing element can, for example, be received between the connection sections such that the sealing element peripherally surrounds the flow openings at the connection sections. Outer contours of the flow openings are thus sealed against each other.

In addition, the sealing element can have sealing webs which separate channel openings from one another, which openings are associated with different cooling channel portions. In this case, connection sections of the wall portions of the cover element can rest against the sealing webs, for example, so that the wall portions forming the cooling channel portions of the housing assemblies are sealed against each other and thus coolant can be introduced from a cooling channel portion of a housing assembly via an associated channel opening into an associated cooling channel portion of the other housing assembly.

In one embodiment, at least one of the housing assemblies has a receiving groove for receiving the at least one electric line. The electric line can be inserted into the receiving groove so that the electric line is received and enclosed between the housing assemblies when the housing assemblies are connected to one another. In this case, the shaping of the receiving groove is preferably adapted to the electric line. For example, the receiving groove can have a semicircular cross section having a diameter corresponding to the diameter of the line, so that the line comes into contact in a planar manner with a boundary portion of the housing assembly forming the receiving groove, when the electric line is received between the housing assemblies.

It is conceivable that such a receiving groove is formed only on one of the housing assemblies. In another embodiment, however, both housing assemblies each have a receiving groove assigned to an electric line, such that in the case of interconnected housing assemblies the electric line lies in the receiving grooves of the housing assemblies and is in contact with the housing assemblies in a planar manner.

The housing module can be designed for cooling multiple electric lines. In this case, for example multiple receiving grooves, into which the multiple electric lines are to be inserted, can be formed (in each case) on one housing assembly or on both housing assemblies.

In one embodiment, the cooling channel is formed and extends in the housing module in such a way that coolant guided in the cooling channel flows around a boundary portion of the associated housing assembly that forms the receiving groove. The boundary portion can have, for example, a semi-cylindrical shape and extend within the flow space defined by the body element of the respective housing assembly. In this case, the cooling channel preferably extends beyond the boundary portion and thus flows around the boundary portion, such that heat can be absorbed and dissipated at the boundary portion.

For example, the cooling channel can extend transversely to the course of the receiving groove formed by the boundary portion. The coolant is thus guided transversely beyond the boundary portion, wherein it is possible for the cooling channel to be formed by multiple meandering cooling channel portions, so that the coolant is guided over the boundary portion several times, along different flow directions.

In one embodiment, the cooling module has at least one connection element for connecting a cooling line. For example, a first connection element for a supply line and a second connection element for a discharge line can be arranged on the cooling module so that coolant can be introduced into the cooling module and also discharged again from the cooling module. In this case, the connection elements can for example be arranged together on one of the housing assemblies. However, it is also conceivable for the stop elements to be arranged on different housing assemblies.

The housing assemblies can, for example, be manufactured in each case from an electrically insulating material, in particular a plastics material. In this case, the housing assemblies preferably have a good thermal conductivity for absorbing and dissipating heat at a line to be cooled.

A plug connector assembly comprises a plug connector part, at least one electric line connected to the plug connector part, and a cooling device according to the type described above. A plug connector assembly of this kind can for example be a component of a charging system for charging an electric vehicle. In this case, the plug connector part can be formed, for example, by a charging socket on the side of an electric vehicle, the electric line extending, for example, from the plug connector part towards a vehicle assembly of the electric vehicle, for example to a storage device, in particular a battery arrangement of the electric vehicle. Cooling on the side of the electric vehicle can thus be made available via the cooling device.

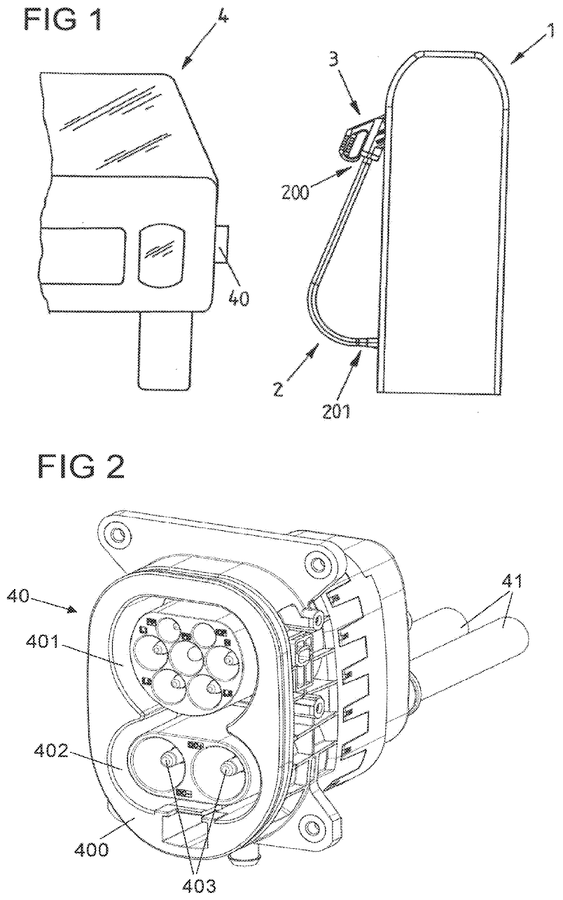

FIG. 1 shows a charging station 1 that serves to charge an electrically powered vehicle 4, also referred to as an electric vehicle. The charging station 1 is designed to provide a charging current in the form of an alternating current or a direct current and has a cable 2 that is connected at one end 201 to the charging station 1 and at another end 200 to a mating plug connector part 3 in the form of a charging plug.

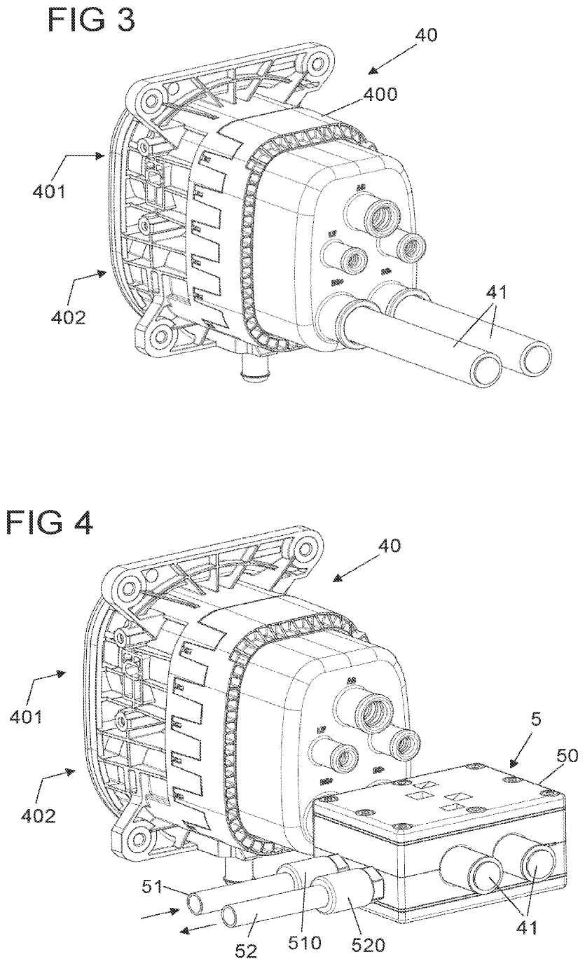

FIGS. 2 and 3 show an embodiment of a plug connector part 40 in the form of a charging socket on the side of the electric vehicle 4. The plug connector part 3 in the form of the charging plug can be connected to the plug connector part 40 in a plugged manner on the charging cable 2 in order to in this way establish a connection between the charging station 1 and the electric vehicle 4 and charge batteries of the electric vehicle 4.

In the embodiment shown, the plug connector part 40 has a housing 400 and plug openings 401, 402 formed on a plug face on the front side of the housing 400, by means of which openings an associated plug connector part 3 can be connected to a charging cable 2 in a plugged manner. Plug portions having electrical contact elements 403 arranged thereon are formed inside the plug openings 401, 402. In this case, contact elements in the region of the upper plug openings 401 serve for transmitting an alternating current. In contrast, contact elements 403 in the region of the lower plug openings 402 serve to transmit a charging current in the form of a direct current.

In the embodiment according to FIGS. 2 and 3, electric lines 41, also referred to as load lines for transmitting a charging current having a high current intensity, are connected to the contact elements 403, so that electrical charging currents can be transmitted via the lines 41 and the connected contact elements 403.

In order to enable fast charging of the electric vehicle 4 within the context of what is known as a fast charging process, the transmitted charging currents have a high current intensity, for example greater than 350 A, possibly even of the order of 500 A or more. As a result of such high charging currents, thermal losses occur at the cable 2 and at the plug connector parts 3, 40, which can lead to heating of the cable 2 and of the plug connector part 3, 40. Likewise, the current-carrying lines 41, which are connected to the plug connector part 40, heat up in the embodiment according to FIGS. 2 and 3.

Excessive heating on the cable 2 and the plug connector part 3 can usually be counteracted by cooling on the cable 2 and/or on the plug connector part 3. In addition, current-carrying components, in particular line cores of the cable 2 and contact elements of the plug connector part 3, are usually dimensioned such that they have a high current-carrying capacity and are designed for continuous operation having a plurality of successive charging processes.

Excessive heating is also to be avoided on the plug connector part 40 and the lines 41 on the side of the electric vehicle 4. Since the plug connector part 40 and the lines 41 connected thereto are usually not subjected to current for a longer period after a charging process has been completed, and can thus cool down again after a completed charging process, the requirements for dimensioning of components on the side of the electric vehicle 4 are usually reduced. However, in this case there are normative limits for permissible maximum heating on the plug connector part 40 and also on the lines 41 connected thereto.

Usually, in this case, a maximum permissible temperature for the plug connector part 40 is different from the maximum permissible temperature for the lines 41. For example, it may be prescribed that the plug connector part 40 may heat up only to a temperature, for example 90° C., which is significantly lower than the maximum permissible temperature of the lines 41, which is for example 180° C. This can lead to the lines 41 being dimensioned having a comparatively small line cross section due to the lower demands, and the lines 41 thus heating more strongly during operation than the plug connector part 40, which can result in heat being introduced from the lines 41 into the plug connector part 40 during operation, which leads to increased heating on the plug connector part 40.

This is to be counteracted in the present case by providing a cooling device 5 as shown in an embodiment in FIGS. 4-12. The cooling device 5 is to be attached to the lines 41, in particular in the region of ends of the lines 41, on which the lines 41 are connected to the plug connector part 40. By means of the cooling device 5, heat is thus intended to be absorbed and dissipated at a transition between the lines 41 and the plug connector part 40, so that heat from the lines 41 is not introduced, or is introduced only to a reduced extent, into the plug connector part 40.

The cooling device 5 has a cooling module 50 to which a supply line 51 and a discharge line 52 for a coolant flow are connected. The supply line 51 is connected to a connection element 510 of the cooling module 50 and serves to introduce coolant into the cooling module 50. Via the discharge line 52, which is connected to a connection element 520 of the cooling module 50, the coolant can be discharged again after flowing through the cooling module 50 in order to in this way transport heat away from the cooling module 50 and in this way provide cooling at the electric lines 41.

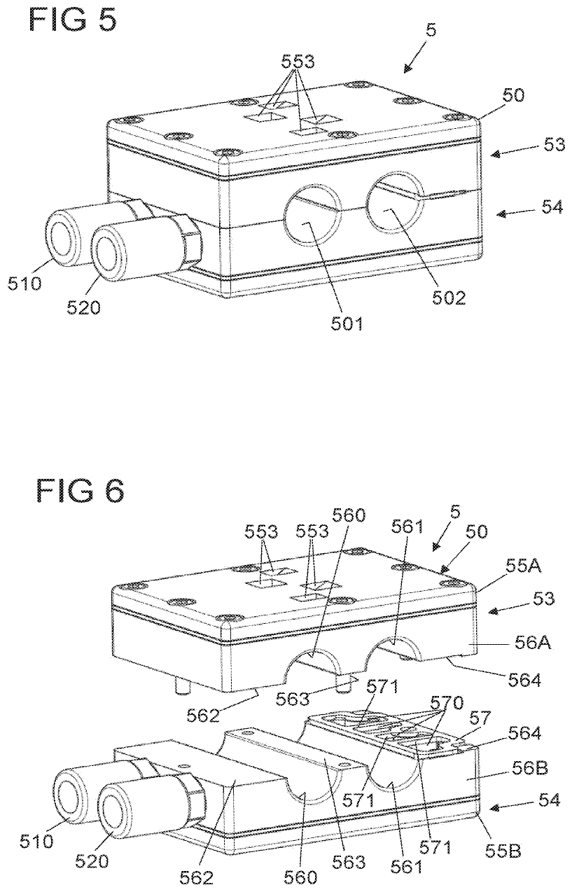

As can be seen from the views according to FIGS. 5 and 6, the cooling module 50 has two housing assemblies 53, 54 which are separate in a preassembly state (FIG. 6) and can be connected together in order, in a connected position (FIG. 5), to form receiving channels 501, 502 therebetween, in which the lines 41 can be received. Via the housing assemblies 53, 54, the cooling module 50 can thus be brought into contact with the lines 41 in order to receive heat at the lines 41 and dissipate it from the lines 41.

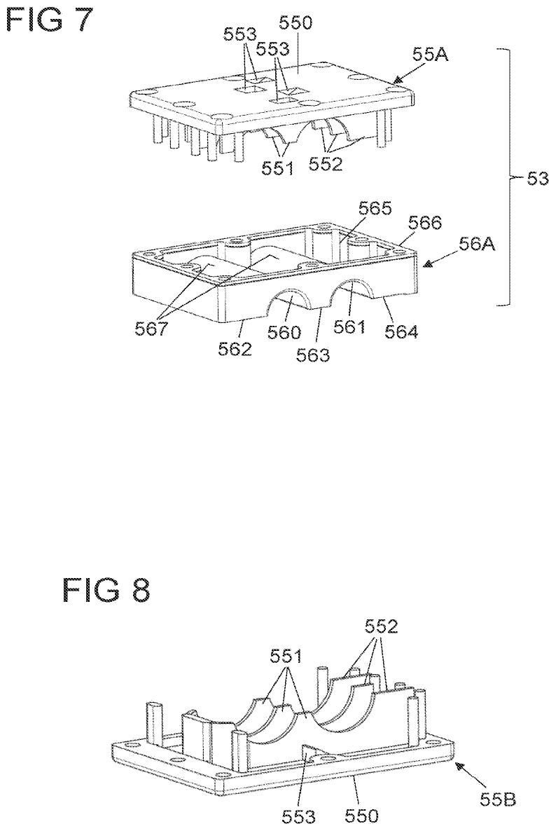

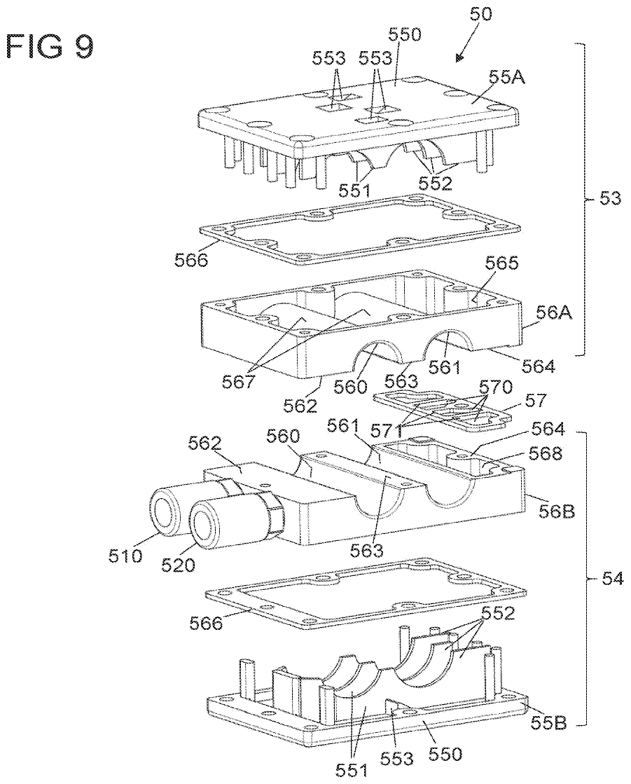

As can be seen from the exploded view according to FIG. 9 and the views according to FIGS. 7 and 8, in the embodiment shown each housing assembly 53, 54 has a body element 56A, 56B and a cover element 55A, 55B connected to the respectively assigned body element 56A, 56B. A sealing element 566 is arranged in each case between the cover element 55A, 55B and the body element 56A, 56B so that a transition between the cover element 55A, 55B and the body element 56A, 56B is sealed in a fluid-tight manner.

Each body element 56A, 56B defines a flow space 565 within which coolant can flow. In this case, the cover elements 55A, 55B each have a surface portion 550 and wall portions 551 formed on the surface portion 550, in the form of webs extending perpendicularly to the surface portion 550, by means of which the cover element 55A, 55B can be inserted into the flow space 565 of the associated body element 56A, 56B in such a way that a lower edge of each wall portion 551 comes into contact with a base of the body element 56A, 56B and cooling channel portions are thus formed in the flow space 565 for forming a cooling channel 503, as will be explained below.

As can be seen from FIG. 6 in overview with FIGS. 7 and 9, receiving grooves 560, 561, which together form the receiving channels 501, 502 (see FIG. 5), are formed in the region of the base of each body element 56A, 56B. The receiving grooves 560, 561 are each formed by semi-cylindrical boundary portions 567 which, as can be seen for example from FIG. 9—extend within the flow space 565 of each body element 56A, 56B.

The housing assemblies 53, 54 form, on mutually facing sides on which the receiving grooves 560, 561 are also formed, connection sections 562-564, by means of which the housing assemblies 53, 54 are brought into contact with one another when the housing assemblies 53, 54 are connected to one another for mounting on associated lines 41, in particular are screwed to one another. In this case, one of the connection sections 562-564 of each housing assembly 53, 54, namely the connection section 564, forms a flow opening 568, which serves to establish a flow connection with the respective other housing assembly 54, 53.

As can be seen, for example, from FIGS. 6 and 9, the connection sections 564 having the flow openings 568 of the housing assemblies 53, 54 formed thereon face one another in such a way that, when housing assemblies 53, 54 are attached to one another, the flow openings 568 come to lie on top of one another and, in the case of interconnected housing assemblies 53, 54, a flow connection between the housing assemblies 53, 54 is thus established. In this case, a sealing element 57 is located between the connection sections 564 and serves for sealing a transition between the connection sections 564 and thus for sealing a flow path formed by the flow openings 568 in the connection sections 564, so that coolant cannot escape to the outside at the transition.

As can be seen from FIG. 9, the sealing element 57 forms a plurality of channel openings 570, which are separated from one another in pairs by sealing webs 571. In this case, each sealing web 571 is assigned a contact portion 552 on an edge of an associated wall portion 551 of each cover element 55A, 55B that is remote from the surface portion 550, so that, when the cooling module 50 is mounted, wall portions 551 of the cover elements 55A, 55B adjoin the sealing webs 571 of the sealing element 57 on both sides, and thus form cooling channel portions in both housing assemblies 53, 54, which are fluidically connected to one another via the connection sections 564 and the flow openings 568 formed therein.

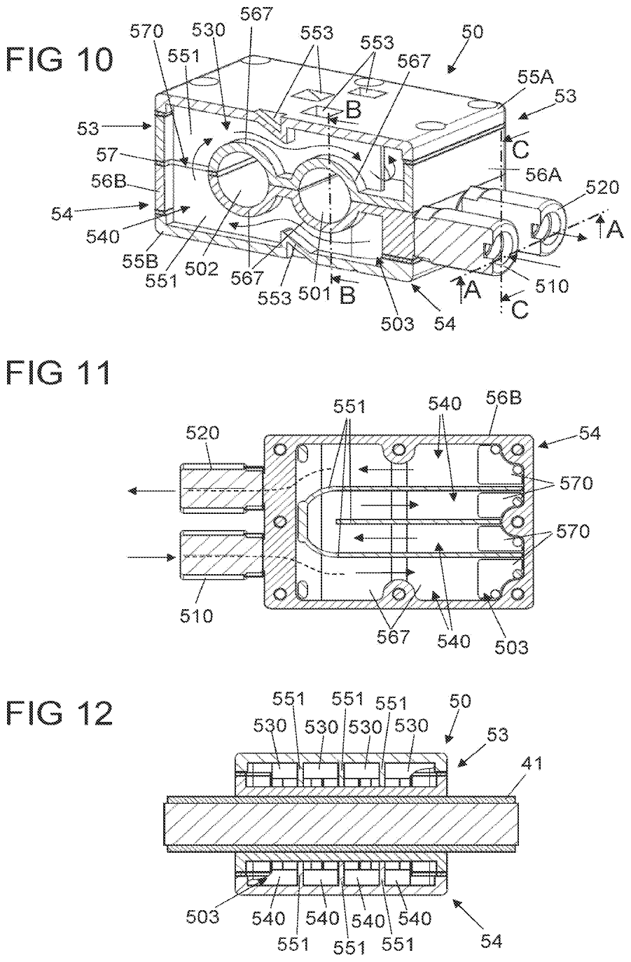

As can be seen from FIGS. 10-13, cooling channel portions 530, 540 are formed within each housing assembly 53, 54 by the wall portions 551 on the cover element 55A, 55B of the housing assemblies 53, 54, said cooling channel portions together forming a cooling channel 503 through which coolant can be conducted for receiving heat can at the electric lines 41.

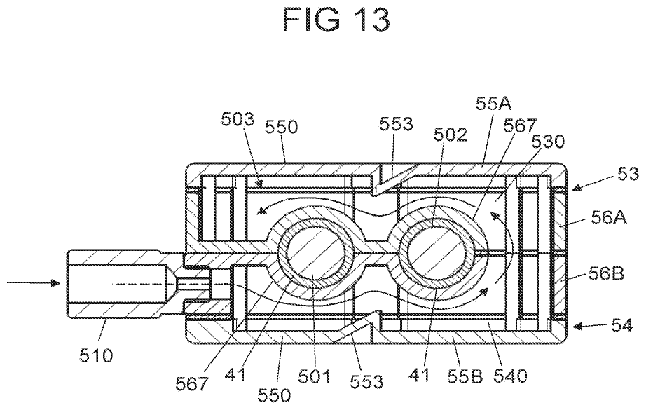

As can be seen from FIG. 10, during operation coolant is introduced, via a supply line 51 connected to the connection element 510, into a cooling channel portion 540 of the housing assembly 54, and flows transversely to the longitudinal extension direction of the lines 41 in the receiving channels 501, 502, beyond the boundary portions 567, in the region of the receiving channels 501, 502. By means of an associated channel opening 570, the coolant flows into a cooling channel portion 530 in the housing assembly 53 and, in turn, now away in the opposite direction, via the receiving channels 501, 502 and into an adjacent, parallel-offset cooling channel section 530 of the housing assembly 53, as can be seen from FIGS. 10 and 13.

After flowing through this cooling channel portion 530, the coolant flow in turn passes through an associated channel opening 570 into a cooling channel portion 540 located underneath in the housing assembly 54 and flows through the housing assembly 54, as can be seen from FIG. 11, in the back and forth direction in order to in turn enter through a channel opening 570 into a further cooling channel portion 530 in the housing assembly 53, to flow through cooling channel portions 530 in the housing assembly 53, and finally to flow through a channel opening 570 into the cooling channel portion 540 of the housing assembly 54 shown at the top in FIG. 11 and to flow out of the cooling module 50 via the connection element 520 and a discharge line 52 connected thereto.

By means of the cooling channel portions 530, 540, which extend in parallel with one another in each housing module 53, 54 and are directed transversely to the longitudinal extension direction of the lines 41 received in the receiving channels 501, 502 (as can also be seen from FIG. 12), a cooling channel 503 is created which runs in a meandering manner in the two housing assemblies 53, 54 and guides the coolant several times back and forth in both housing assemblies 53, 54 via the receiving channels 501, 502 and thus the electric lines 41 received therein. Heat can thus be absorbed at the lines 41 and conducted away from the lines 41.

As can be seen from FIG. 13 in conjunction with FIG. 10, flow elements 553 which project as hook-shaped projections into the region of the cooling channel portions 530, 540 within the associated housing assembly 53, 54 are formed on the surface portion 550 of each cover element 55A, 55B and serve to shape the coolant flow through the cooling channel portions 530, 540 such that in particular a flow is formed around the boundary portions 567 forming the receiving channels 501, 502 on the body element 56A, 56B and heat can be efficiently absorbed at the boundary portions 567.

The body elements 56A, 56B and the cover elements 55A, 55B advantageously consist of an electrically non-conductive material, in particular a plastics material, which preferably has high thermal conductivity. The coolant flow guided in the housing assemblies 53, 54 is thus electrically separated from the lines 41 received in the receiving channels 501, 502.

Alternatively, however, the body elements 56A, 56B may also be made of an electrically conductive material, for example an aluminum material, the lines 41 being electrically insulated from the body elements 56A, 56B via an insulating line jacket.

The fact that the housing assemblies 53, 54 are separate from one another in a preassembly state and can be attached to one another in order to mount the housing module 50 on lines 41 to be cooled results in a simple assembly, in particular also with the possibility of retrofitting when the lines 41 are already mounted and connected to an associated plug connector part 40.

The coolant can in particular be a coolant liquid, for example a water/glycol mixture. However, other coolant in the form of liquid or gaseous fluids can also be used for cooling.

The concept on which the invention is based is not limited to the embodiments described above, but can also be implemented in another manner.

A plug connector part of the type described can advantageously be used on a charging system for charging an electric vehicle. In principle, however, a different application is also conceivable, in particular where large currents are to be transmitted and therefore cooling is to be provided on a plug connector assembly.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Charging station
2 Charging cable
200, 201 End
3 Plug connector part (charging plug)
4 Vehicle
40 Plug connector part (charging socket)
400 Housing
401, 402 Plug portion
403 Electrical contact element
41 Load line
5 Cooling device
50 Cooling module
501, 502 Receiving channel
503 Cooling channel
51 Supply line
510 Connection element
52 Discharge line
520 Connection element
53, 54 Housing assembly
530, 540 Cooling channel portions
55A, 55B Cover element
550 Surface portion
551 Wall portions
552 Contact portions
553 Flow element
56A, 56B Body element
560, 561 Receiving groove
562-564 Connection section
565 Flow space
566 Sealing element
567 Boundary portion
568 Flow opening
57 Sealing element
570 Channel opening
571 Sealing webs

1. A cooling device for cooling at least one electric line which is connected to a plug connector part having comprising:
a cooling module disposable on the at least one electric line and having a cooling channel for flowing coolant therethrough, the cooling module having two housing assemblies, each of which has a respective connection section and a flow opening molded onto the connection section, the two housing assemblies being separate in a preassembly state and being connectable together to be placed on the at least one electric line such that the at least one electric line is received between the housing assemblies,
wherein the flow openings of the connection sections of the two housing assemblies are fluidically connected together to form the cooling channel.

2. The cooling device of claim 1, wherein each housing assembly has at least one cooling channel portion for forming the cooling channel.

3. The cooling device of claim 2, wherein the at least one cooling channel portion of one housing assembly of the two housing assemblies is fluidically connected to the at least one cooling channel portion of an other housing assembly of the two housing assemblies when the two housing assemblies are connected to one another.

4. The cooling device of claim 2, wherein at least one housing assembly of the two housing assemblies has a body element and a cover element connected to the body element, the body element defining a flow space in which the at least one cooling channel portion extends.

5. The cooling device of claim 4, wherein the cover element has a surface portion defining the flow space and at least one wall portion formed on the surface portion for defining the at least one cooling channel portion.

6. The cooling device of claim 5, wherein the at least one wall portion extends towards the connection section of the at least one housing assembly such that the at least one wall portion divides the flow opening into multiple channel openings.

7. The cooling device of claim 5, wherein the cover element has a plurality of wall portions between which cooling channel portions are formed.

8. The cooling device of claim 5, wherein at least one flow element protruding into the at least one cooling channel portion is formed on the surface portion.

9. The cooling device of claim 1, wherein the cooling module has a sealing element arranged between the connection sections of the two housing assemblies.

10. The cooling device of claim 9, wherein the sealing element has a plurality of sealing webs that separate channel openings associated with different cooling channel portions from one another.

11. The cooling device of claim 1, wherein at least one housing assembly of the two housing assemblies has a receiving groove configured to receive the at least one electric line.

12. The cooling device of claim 11, wherein the cooling channel is shaped such that coolant guided in the cooling channel flows around a boundary portion of the at least one housing assembly that forms the receiving groove.

13. The cooling device of claim 1, wherein the cooling module has at least one connection element for connecting a cooling line.

14. A plug connector assembly, comprising:
a plug connector part;
at least one electric line connected to the plug connector part; and
the cooling device of claim 1 for cooling the at least one electric line.

15. A charging system for charging an electric vehicle, comprising:
the plug connector assembly of claim 14.
